(19) United States
(12) Patent Application Publication
(10) Pub. No.: US 2026/0338719 A1
(43) Pub. Date: Oct. 29, 2026

(54) DEVICE, DESIGNED FOR CARRYING OUT X-RAY FLUORESCENCE ANALYSIS OF AT LEAST ONE CHEMICAL FLUID BATH, AND METHOD USING THE DEVICE

(71) Applicant: X-Ray Sensor GmbH, Karlsruhe (DE)

(72) Inventors: Michael HALLER, Middletown, CT (US); Bernhard NENSEL, Karlsruhe (DE)

(73) Assignee: X-Ray Sensor GmbH, Karlsruhe (DE)

(21) Appl. No.: 19/116,024

(22) PCT Filed: Oct. 17, 2023
(86) PCT No.: PCT/EP2023/078770

§ 371 Date: Mar. 27, 2025

(30) Foreign Application Priority Data
Oct. 18, 2022 (DE) 10 2022 127 195.1

(51) Int. Cl. G01N 23/223; G01N 23/2204

(52) U.S. Cl. CPC G01N 23/223; G01N 23/2204; G01N 2223/307; G01N 2223/637

(57) ABSTRACT

A device for online x-ray fluorescence analysis of a chemical fluid from at least one chemical fluid bath includes a housing, a sample holder and an x-ray fluorescence spectrometer, which provides a beam path with an input beam into the sample holder and an output beam of emitted x-ray radiation from the sample holder, the input and the output beams spanning a beam path plane. The sample holder is a tube mount having a plurality of channels, each for a tube that is fluidically connected to the chemical fluid bath. The channels are arranged adjacently to one another in a tube plane that is orthogonal to the beam path plane, the tube mount having a beam path window at each of the channels, the beam path window being arrangeable in relation to the beam path plane such that the input and the output beams cross the beam path window.

### CROSS-REFERENCE TO RELATED APPLICATION

This application is a national stage application, filed under 35 U.S.C. § 371, of International Patent Application PCT/EP2023/078770, filed on Oct. 17, 2023, which claims the benefit of German Patent Application DE 10 2022 127 195.1, filed on Oct. 18, 2022.

### TECHNICAL FIELD

The invention relates to a device, which is designed for carrying out x-ray fluorescence analysis of at least one chemical fluid bath, and a method for using said device.

### BACKGROUND

It is known from the prior art to examine the metal content in galvanic baths, such as, e.g., zinc-nickel baths, with the help of an x-ray fluorescence device. For this purpose, samples are taken manually from the respective bath to be examined and the samples are analyzed by means of the x-ray fluorescence device. Galvanic baths of this type have to be monitored continuously in order to check and optionally control the content of metal ions, which is why samples have to be taken from each bath at regular time intervals. However, the manual taking and analysis of the samples are time-consuming and thus cost-intensive.

### SUMMARY

The present disclosure describes an improved device for the easy and quick analysis of chemical fluid baths and a method for carrying out a simple and quick analysis of chemical fluid baths.

According to a first embodiment of a device, which is designed for carrying out online x-ray fluorescence analyses of at least one chemical fluid of a chemical fluid bath, this device has a housing, a sample holder and an x-ray fluorescence spectrometer. The x-ray fluorescence spectrometer provides a beam path of an input beam into the sample holder and an output beam of emitted x-ray radiation from the sample holder. The input and the output beam thereby span a beam path plane. The sample holder is a tube mount, which has several channels, for one tube each per channel, which is fluidically connected to the chemical fluid bath. This means that a tube, which is connected to the chemical fluid bath, is assigned to one channel of the number of channels. This number of channels is arranged in the tube mount adjacent to one another in a tube plane E, which is orthogonal to the beam path plane S. On each of the channels, the tube mount has a beam path window, which, with respect to the analysis with respect to the beam path plane S is arranged in such a way that the input and the output beam intersects with the beam path window.

The x-ray fluorescence spectrometer emits a primary x-ray beam into the sample holder and excites atoms of the fluid to be tested there. The excited atoms also emit material-characteristic fluorescence radiation in the x-ray range at an exit angle, which is equal to the entry angle of the primary x-ray beam and thus corresponds to a reflected output beam.

“Online” hereby means that the x-ray fluorescence analysis is carried out directly in a bypass line of the chemical fluid bath, which is formed by the tube, which, by means of arrangement in or combination with the tube mount, leads to the x-ray fluorescence spectrometer and is linked directly to the fluid bath. No further operating step is necessary, such as the manual removing and analyzing of samples from the fluid bath but a chemical fluid bath can advantageously be connected easily to the x-ray fluorescence spectrometer, so that a directly connected analysis is made possible. The fluid flows through the tube to the channel with the beam path window and can be analyzed there with the help of the x-ray radiation, without leaving the bypass line, and can be guided back to the bath again. There is no need for manually removing a sample of the bath to be analyzed and separately measuring the sample. The analysis can thus advantageously be used in a demand-driven manner and also several times in a row, without interrupting the respective process, which takes place in the respective fluid bath.

According to a further embodiment of the device, the tube mount can be displaced in the tube plane E orthogonal to the beam path plane S in a direction, which runs orthogonal to the channels. Each of the beam path windows can thereby be arranged with the tube mount with respect to the beam path plane in such a way that the input and the output beam intersects with the respective beam path window.

According to yet a further embodiment, the beam path window can be formed by means of an opening in the channel wall without filling, wherein the tube, which is assigned to the channel, is arranged in the channel or extends continuously through the channel, respectively.

According to an alternative embodiment for this, the beam path window can be formed by means of an opening, which is closed by means of a window filling so as to form a seal with the channel wall, wherein a feeding and return tube section is in each case connected to the channel input and the channel output, so that the tube, which is assigned to the channel, is quasi interrupted by the channel. In the first case, the tube and, in the second case the window filling consists of a material, which is transparent for x-ray radiation on the one hand and which is stable with respect to x-rays on the other hand.

Flexible tubular semi-finished products made of elastomers or thermoplastics and preferably thin-walled chemical tubes are suitable usable tubes.

In a suitable manner, the tube is a laboratory and vacuum tube. It can have, for example, a diameter of 4 to 10 mm on the inside, preferably 5 to 7 mm on the inside, particularly preferable of 6.4 mm on the inside, and of 5 to 12 mm on the outside, preferably 7 to 9 mm on the outside, particularly preferably 7.9 mm on the outside. X-ray radiation can transmit with a suitable intensity through a polymer wall with a thickness of, for example, 0.75 mm, so that such a tube is suitable for the arrangement in a tube mount without window filling. The information relating to the inner and outer diameters of the laboratory and vacuum tube, are to not be understood to be limiting but only as an example.

According to yet a further embodiment of the device, one tube each is assigned to each number of channels, wherein a first tube is fluidically connected to a first chemical fluid bath and each of the further tubes is fluidically connected to a further chemical fluid bath. In the case of two channels, which are each connected to one tube or in which a tube is present in each case, the device can thus be connected to two fluid baths and each channel, which is assigned to a tube, can be displaced with the beam path window into the beam path plane due to the displaceability of the tube mount, and the fluid supplied through the respective tube can be analyzed in an advantageous and skilled manner without manual intervention with the help of the x-ray fluorescence spectrometer.

According to yet a further embodiment of the device, the tube mount is operatively coupled to a drive motor via a coupling device. The displacing of the tube mount thus advantageously takes place in a guided motorized and exact manner. For this purpose, the coupling device has at least one lever element and one transmission linkage, wherein the lever element connects the drive motor and the transmission linkage, which is connected to the tube mount.

According to yet a further embodiment of the device, the lever element, which is of elongate design, has, on a first end, a triangular clamping recess, the one corner of which leads into a slit, which opens towards the first end. A threaded bore extends at a right angle from a long, narrow side surface through the slit. Adjacent to its second end, the elongate lever element has a passage bore. A shaft extends away from the drive motor and is fixed in the triangular recess. A threaded pin is arranged in the threaded bore and clamps the shaft in the triangular recess.

To improve the rotationally fixed connection to the lever element, the shaft can have a triangular or hexagonal profile or an end section with edge profile, respectively, for the positive connection to the triangular recess.

On the other end of the lever element, a pin is rotatably arranged in the passage bore, which pin couples the lever element to the transmission linkage. This is an L-shaped linkage consisting of two legs, which are pivotably connected to one another, wherein the lever element is pivotably coupled to the free end of a short leg. A long leg of the L-shaped linkage is fastened to a side of the tube mount facing away from the beam path windows and extends parallel to the channels. With the transmission linkage, the lever element serves for the movement transmission of the rotation of the motor shaft into a translational movement of the tube mount in a direction, which runs at a right angle to the channels or to the long leg of the transmission linkage, respectively, which lies in a plane parallel to the tube plane E of the tube mount. The movement transmission components can thus be arranged in a compact and space-saving manner.

According to a further embodiment of the device, each channel has an x-ray beam sink with respect to the beam path window in a region of incidence of the input beam, i.e., in the direction of the input beam. For this purpose, a blind hole can branch off from the channel on a side facing away from the beam path window at an angle corresponding to the inclination of the input beam in order to provide an x-ray beam sink, by means of which x-ray radiation of the input beam, which passes through the channel, is caught or absorbed, respectively. For shielding purposes to the outside, the tube mount can consist of a steel, preferably a nickel-free stainless steel (403 steel). A further housing sheath or a housing cover can also be provided, which covers the tube mount and which consists of this material.

According to yet a further embodiment of the device, the tube mount is connected to at least one pivot linkage, which is fastened to the housing, so as to be pivotable in the tube plane E in a direction orthogonal to the channels. The movement of the tube mount, which is transmitted with the help of the lever element from the motor by means of the transmission linkage, which engages on one side with one end of the tube mount, is stabilized in the movement plane by means of the pivot linkage, which is articulated on both sides of the tube mount. Depending on the direction, in which the motor shaft rotates and displaces the tube mount in a direction orthogonal to the channels, the moved tube mount is held in the tube plane E by means of the pivot linkage, which is fastened to the housing and which follows the movement of the tube mount, whereby the beam path windows of the channels, which lie next to one another, can be displaced systematically into the beam path plane S.

For the improved guidance of the tube mount according to a further embodiment of the device, it can alternatively or additionally be provided that the tube mount is guided by means of at least one guide element, which is fastened to the housing and runs in the direction orthogonal to the channels of the tube mount. The guide element can be formed in different ways and, according to one embodiment, it can be a guide rail or a gear wheel belt drive. Other mechanism, which provide for an easy displacing of the tube mount, are also possible in addition to a gear wheel belt drive. One or more polytetrafluoroethylene-coated strips can particularly preferably be used as guide elements. They make it possible that the tube mount can be displaced with very low abrasion along the housing.

In order to further ensure that no gap is created between the tube mount and the housing in the region of the beam path window, which is located in the beam path, a device can, according to a further embodiment, have, on a side of the tube mount facing away from the beam path window, a counter bearing device with a ball mounted so as to be capable of rolling, which pushes the tube mount in the direction of the housing orthogonal to the tube plane E in the region of the beam path plane S.

According to a further embodiment of the device, a control device is arranged in the housing, which control device is electronically coupled to the drive motor and the x-ray fluorescence spectrometer, in order to provide for an automatic control with simple operation. A storage of the measured data as well as an evaluation (analysis) and the display of the data can further take place. For this purpose, the device can have a corresponding storage, evaluation and display unit in the housing or the control unit can have a suitable interface. The control unit can be connected in a wired or wireless manner to an external data processing unit by means of this interface.

According to a further embodiment of the device, the at least one tube, which is fluidically connected to the chemical fluid bath, is coupled to a pump. The pump serves for the systematic supply of the fluid in the tube to the tube mount and also for the purpose that the already analyzed fluid is guided back into the respective bath again. A single pump or several pumps can be provided, one for each tube.

According to yet a further embodiment of the device, the chemical fluid bath is preferably a galvanic bath. A predetermined content of different metal ions, which has to be controlled continuously so that the concrete composition of the bath remains constant or can be adapted depending on the application, respectfully, is located in galvanic baths.

The invention further relates to a method for the online x-ray fluorescence analysis of a chemical fluid from at least one chemical fluid bath by using the device according to the disclosure. The method thereby comprises the following steps:
a) establishing the fluidic connection of the at least one tube, which is assigned to one of the channels of the tube mount, to the chemical fluid bath, and thus providing the chemical fluid through the tube in the assigned channel,
b) turning on the x-ray fluorescence spectrometer and generating the beam path of the input beam of generated x-ray radiation and the output beam of emitted x-ray radiation, thereby irradiating the chemical fluid,
c) analyzing the chemical fluid by detection of the emitted x-ray radiation.

In a further embodiment, the method can comprise the further step of:
d) repeating at least step c) after a predetermined time period. The time period preferably lies in a range of a few minutes to several hours. The method can be automated via the control unit, so that a manual removal or also manual use of the spectrometer is no longer necessary. The generation of the beam path in step b) for the analysis of the chemical fluid can thus likewise take place after the predetermined time period by detection of the emitted x-ray radiation in step c).

Lastly, the disclosure relates to a method for the online x-ray fluorescence analysis of a first chemical fluid from a first chemical fluid bath and of at least one further chemical fluid from a further chemical fluid bath by using the device according to the disclosure, which comprises the following steps:
aa) establishing the fluidic connection of a first one of the plurality of the tubes, which is assigned to a first one of the channels of the tube mount, which is fluidically connected to the first chemical fluid bath, and thus providing the first chemical fluid through the first tube in the first channel and positioning the beam path window of the first channel with the tube mount in the beam path,
bb) turning on the x-ray fluorescence spectrometer and generating the beam path of the input beam of generated x-ray radiation and the output beam of emitted x-ray radiation, thereby irradiating the first chemical fluid,
cc) analyzing the first chemical fluid by detection of the emitted x-ray radiation,
dd) establishing the fluidic connection of a further one of the plurality of the tubes, which is assigned to a further one of the channels of the tube mount, to one of the further chemical fluid baths, and thus providing the further chemical fluid in the further channel,
ee) displacing the tube mount in the tube plane E and positioning the beam path window of the further channel in the beam path after analysis of the first chemical fluid,
ff) analyzing the second chemical fluid by detection of the emitted x-ray radiation.

Technically possible changes to the order of some sub-steps are to be comprised hereby, e.g., the step dd) of establishing the fluidic connection of a further tube to a further chemical fluid bath can thus take place immediately after step aa) of establishment of the fluidic connection of the first tube to the first chemical fluid bath, so that all fluid baths are first assigned to one of the channels of the tube mount via the respective tubes, before the respective fluid is provided through the tube in the assigned channel. It is to further be comprised that the generation of the beam path in step bb) after the analysis of the first chemical fluid in step cc) is interrupted in response to the displacement of the tube mount in step ee) and is continued only with the positioning of the beam path window of the further channel in the beam path, in order to provide for the analysis of the second chemical fluid in step ff).

In a further embodiment, the method further comprises the further step of:
gg) repeating steps aa) to ff) or of steps dd) to ff) and thereby analyzing the chemical fluids once or several times in all tubes assigned to the channels.

In yet a further embodiment, the method can furthermore comprise the step of: d) repeating steps cc) and ff) after a predetermined time period. The tube mount can thus be displaced after each analysis, so that the beam path window of a different channel is positioned in the beam path during each analysis, in order to alternately analyze the fluids from each fluid bath, which is assigned to one of the channels via a tube. Several analyses of a fluid can alternatively take place one after the other, if different analysis intervals are provided for different fluid baths, whereby the tube mount maintains the position before the tube mount is displaced, in order to displace the beam path window of a different channel into the beam path for the analysis of a different fluid.

Further embodiments of the device as well as some of the advantages, which are associated with these and further embodiments, become clear and more easily understandable by means of the following detailed description with reference to the accompanying figures. Objects or parts thereof, which are essentially identical or similar, can be provided with the same reference numerals. The figures are only a schematic illustration of an embodiment of the invention.

### BRIEF DESCRIPTION OF THE DRAWINGS

FIG. 1 shows a view from the top into a housing of a device for carrying out online x-ray fluorescence analyses of at least one chemical fluid of a chemical fluid bath.

FIG. 2 shows a sectional view through a portion of the device.

FIG. 3 shows a perspective view onto the tube mount onto a side facing the housing.

FIG. 4 shows a schematic diagram of the setup of the device.

FIG. 5 shows a perspective view onto the tube mount onto a side facing away from the housing.

FIG. 6 shows a sectional view through a channel according to FIG. 5, section A-A.

FIG. 7 shows a perspective view of the lever element.

FIG. 8 shows a schematic view of the device with the tube mount in a first position.

FIG. 9 shows a schematic view of the device with the tube mount in a further position.

FIG. 10 shows a schematic view of the device with the tube mount in yet a further position.

FIG. 11 shows a view of a further embodiment of the device from the top.

### DETAILED DESCRIPTION

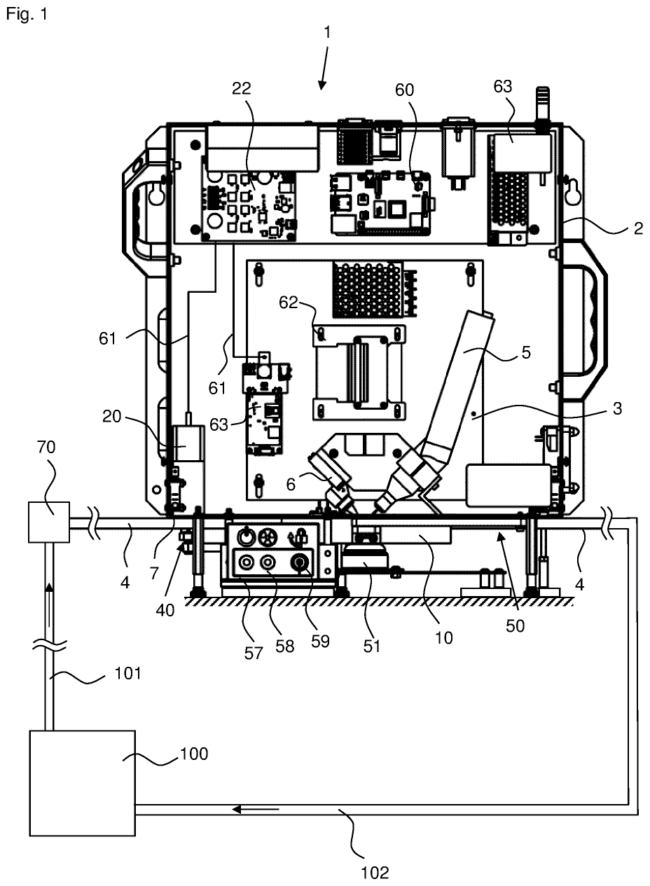

A device 1, which is designed for carrying out one or more x-ray fluorescence analysis/analyses of a chemical fluid bath 100 online, has a housing 2, as shown in FIGS. 1, 2 and 4. An x-ray fluorescence spectrometer 3 as well as a motor 20 and a control device 60 of the device 1 is arranged in the housing 2. On a side of the housing 2 facing the x-ray fluorescence spectrometer 3, a sample mount in the form of a tube mount 10 is arranged outside of said housing, into which a tube 4 is inserted. The tube mount 10 is located below the housing 2 here, which is thus elevated onto a surface (suggested in FIG. 1). The x-ray fluorescence spectrometer 3 has its own control unit 62, which, as well as the motor 20, is connected via electrical lines 61 to a control device 22 of the device 1, which is assigned to the motor 20. The circuit board 63 illustrated in the x-ray fluorescence spectrometer 3 is a detector adapter board, which is operatively coupled to the control device 60. The device 1 can be connected to an external power source (not illustrated figuratively) via a power connection device 63, which is arranged in the housing 2. The power connection device 63 is electrically connected (not illustrated figuratively) to the electronic components of the device 1. A control panel 57, which has an on/off light 58 and a key switch 59, is further arranged on the front side of the housing 2, so that the device 1 can be turned on and off securely. The tube 4 is fluidically connected to a chemical fluid bath 100, wherein a fluid circuit is formed, which is directed in a preferred direction by means of a pump 70, as is clarified by means of directional arrows. The fluidic connection is provided by means of fluid lines 101, 102, which can be identical to the tube 4 or which are connected directly thereto, as shown in FIG. 1.

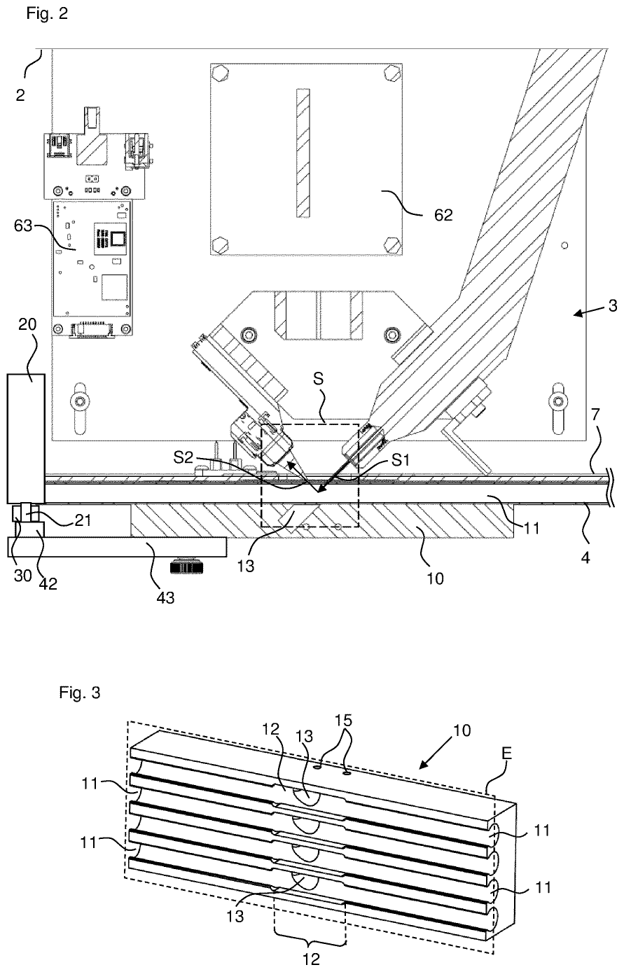

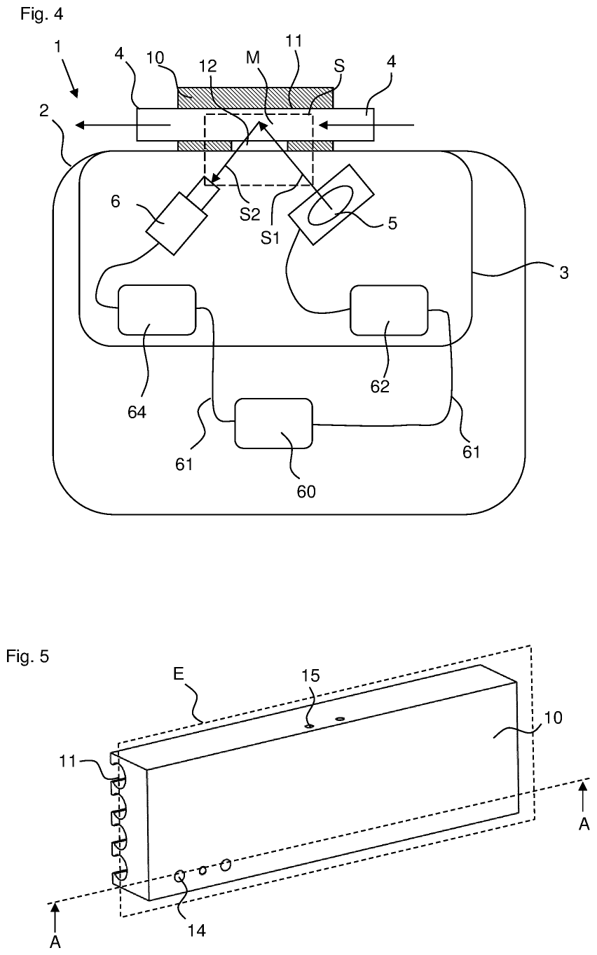

The x-ray fluorescence spectrometer 3 has an x-ray beam source 5 and a detector 6, which are arranged at a 90° angle to one another, as is shown in FIGS. 2 and 4. The x-ray beam source 5 is controlled by the control unit 62. The x-ray beam source 5 generates an input beam S1 directed at the tube mount 10 of x-ray radiation, which passes through the beam path window 12 and the tube wall, excites the fluid within the tube 4 and generates fluorescence radiation, which is directed as output beam S2 through the beam path window 12 into the detector 6, which converts the analog electrical signal into a digital signal by means of a digital pulse processor 64 (DPP) that is then provided as spectrum for the further data processing. Input beam S1 and output beam S2 span a beam path plane S, which is at a right angle to the housing wall 7, which faces the tube mount 10. Where the input beam S1 interacts with the fluid in the tube 4 and becomes the output beam S2, a region is present in the tube 4, which can be interpreted as measuring cell M and the dimensions of which correspond to the diameter of the tube 4 with the expansion of the x-ray beam.

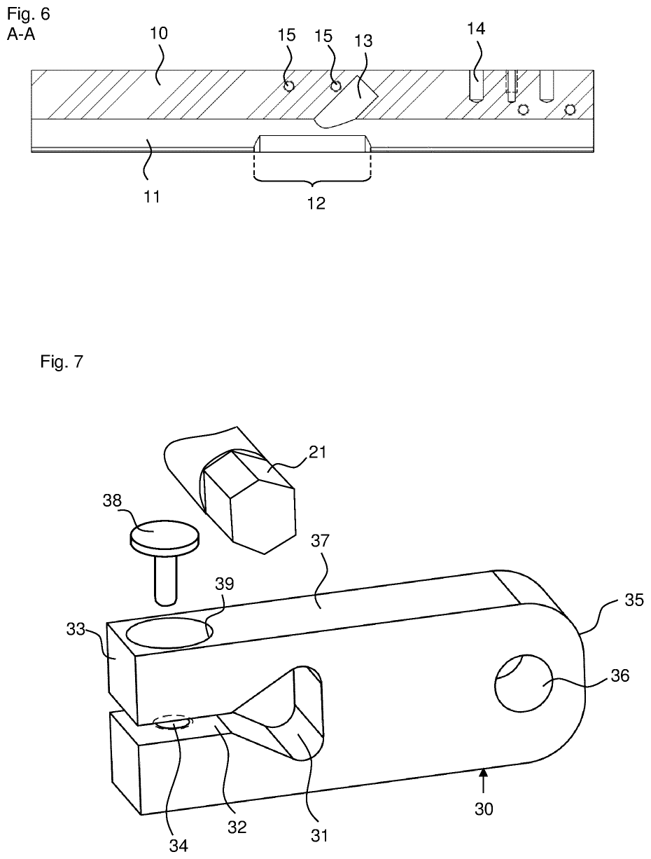

According to FIGS. 3, 5 and 6, the tube mount 10 has four channels 11, into which a total of four tubes can be inserted. The channels 11 lie next to one another in a tube plane E, which lies orthogonal to the beam path plane S, and have a cross section, which is partially circular, wherein the tubes, which are inserted, are held by the cross section. In each channel 11, the tube mount 10 has a beam path window 12, which opens towards the x-ray fluorescence device 3. Said beam path window extends parallel to the tube plane E, as can be seen in FIG. 4, and thus at a right angle, as can be gathered from FIG. 2, 4, to the beam path plane S. On the side lying opposite the beam path window 12, an x-ray beam sink 13 branches off from the channel 11 in a region, which lies in the direction of the input beam path S1. Said x-ray beam sink can be filled with a shielding material. The tube mount 10 is movably mounted in front of the wall 7 of the housing 2, so that each beam path window 12 of each channel 11 can be displaced into the beam path plane S or into a position, respectively, in which the beam path plane S intersects the beam path window 12, so that the beam path of input and output beam S1, S2 into the and out of the tube 4 runs through the beam path window 12. Each tube 4, which is present in the tube mount 10, can thus reach into the bean path plane S, in order to analyze the fluid contained therein by means of the x-ray fluorescence spectrometer 3. Each tube 4 can be connected to a different fluid bath 100, so that different baths can be controlled.

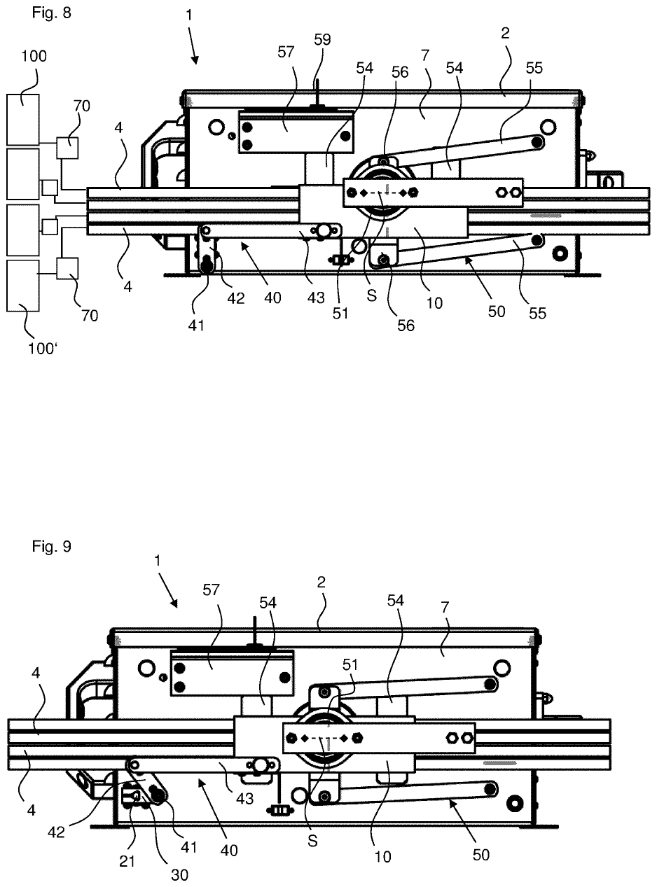

The tube mount 10 is connected to the housing 2 so as to be capable of being shifted orthogonal to the channels via a coupling device in the tube plane E. The coupling device comprises, as shown in FIG. 1, 2 and FIG. 8 to 10, a pivot linkage 50, an L-shaped linkage 40 as well as an elongate lever element 30, which connects the L-shaped linkage 40 to the drive motor 20. For the fastening of the coupling device to the tube mount 10, first fastening bores 14 are provided in the tube mount 10 on the rear side facing away from the beam path windows 12 and second fastening bores 15 are provided on two longitudinal side surfaces (see FIG. 3, 5, 6), wherein the L-shaped linkage 40 is fastened to the first fastening bores 14 and the pivot linkage 50 is fastened to the second fastening bores 15 (see FIG. 8 to 10). As shown in FIG. 7, the lever element 30 has a triangular recess 31 on its first end 33. The one corner 32 thereof leads into a slit 34, which extends all the way to the first end 33 and opens there. From a long side 37, a threaded bore 39 extends through the slit 34 at a right angle. Adjacent to its second end 35, a through bore 36 is provided in the elongate lever element 30. A shaft 21, which is arranged in the triangular recess 31, extends away from the drive motor 20. A threaded pin 38 can be arranged in the threaded bore 39 and clamps the shaft 21 in the triangular recess 31. For the rotationally fixed arrangement of the shaft 21 in the triangular recess 31, the end section of the shaft 21 has a hexagonal profile, which is received in a positive manner in the triangular recess 31. Alternatively, the shaft 21 can have a triangular or polygonal profile, in the case of which three edges correspond to the triangular recess 31.

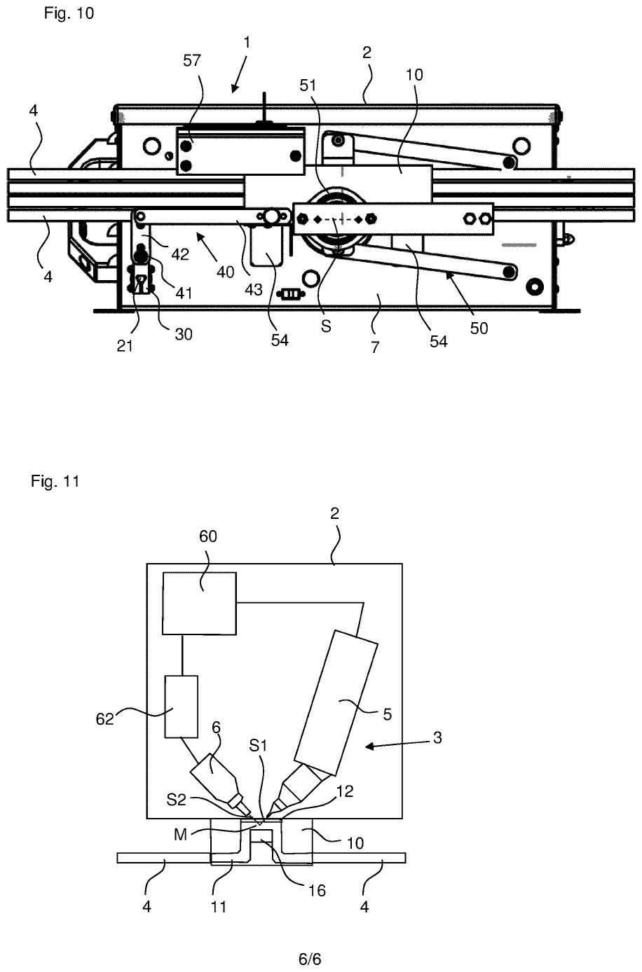

As shown in FIGS. 9 and 10, a pin 41 is rotatably arranged in the passage bore 36, which pin connects the lever element 30 to the L-shaped linkage 40. The L-shaped linkage 40 has a short leg 42 and a long leg 43, which are pivotably coupled to one another. The lever element 30 is articulated on the free end of the short leg 42, which covers the lever element 30 in the arrangement shown in FIG. 8. The long leg 43 of the L-shaped linkage 40 is fastened in the fastening bores 14 on a side of the tube mount 10 facing away from the channels 11.

The pivot linkage 50 is formed from two pivot rods 55, which run parallel to one another. A first end of each rod 55 is rotatably connected to the wall 7 of the housing 2, and a second end is pivotably mounted in a mount 56, which is connected to the tube mount 10 via the fastening bores 15. They form a movement guidance for the back and forth movement of the tube mount 10 in the tube plane E, which is transmitted from the long leg 43 of the transmission linkage 40 to the tube mount 10 at the position of the fastening bores 14. The tube mount 10 is further supported in the back and forth movement by means of two parallel polytetrafluorethylene-coated strips 54, which are fastened to the housing 2 and run in a direction orthogonal to the channels 11 of the tube mount 10. The strips 54 serve as additional guide elements and simplify the displacement movement of the tube mount 10.

In order to minimize the distance of the tube mount 10 from the housing 2 in the region of the beam path plane S, the device 1 has a counter bearing device 51, which pushes the tube mount 10 with the beam path window 12 arranged in the beam path plane S orthogonal to the tube plane E in the direction of the housing 2. The counter bearing device 51, which acts on the rear side, i.e., the side of the tube mount 10 facing away from the beam path window 12, allows for the displacement of the tube mount 10. The counter bearing device can be a ball (not illustrated figuratively), which is mounted in a bearing shell so as to be capable of rolling and which can be made, e.g., of polytetrafluoroethylene-containing material.

The motion sequence, which, due to the interaction between drive motor 20 and the coupling device, displaces the tube mount 10 in the tube plane E parallel to the wall 7 of the housing 2 and orthogonal to the course of the channels or tubes 4, respectively, is illustrated in FIG. 8 to 10. In FIG. 8, a tube 4, which is on the top in the illustration, is fluidically connected to a first fluid bath 100 via the pump 70, and the further tubes 4 are fluidically connected to further fluid baths 100′ via a further pump 70.

In FIG. 8, the lever element 30 points vertically downwards in the illustration starting at the first end 33 connected to the motor shaft 21, so that the short leg 42 of the L-shaped linkage 40, which is articulated on the second end 35 by means of pin 41, points vertically upwards and thus covers the lever element 30. With this position of the lever element 30, the long leg 43, which is fixed on the tube mount 10 parallel to the channels or tubes 4, respectively, is thus at a right angle to the short leg 42 and assumes a lower position in the illustration. The pivot linkage 50 is pivoted “downwards” with the tube mount 10, which is connected to the long leg 43. The tube mount 10 is accordingly located in a “lower position”, so that the “uppermost” tube 4, which is connected to the first fluid bath 100, comes to rest in the beam path plane S, as can be seen on the counter bearing device 51, the position of which depends on the position of the bean path plane S.

If the drive motor 20 is actuated, the shaft 21 rotates counter-clockwise and rotates the lever element 30 into a horizontal position pointing to the right in the illustration, FIG. 9. The short leg 42 of the L-shaped linkage 40 points obliquely upwards to the left at an angle of approximately 45° and pushes the long leg 43 and thus the tube mount 10 “upwards”. This movement is guided by means of the rods 55 of the pivot linkage 50, so that the long leg 43 draws an angle of approximately 45° with the short leg 42. The next tube 4 (the second tube 4 when viewed from the top) is now located in the beam path plane S and the fluid provided therein can be irradiated and analyzed by means of the x-ray fluorescence spectrometer 3.

An arrangement of the device 1 with the tube mount 10 in a position, in which the next tube 4 (the third tube 4 when viewed from the top) is located in the beam path plane S, is not illustrated. For this purpose, the shaft 21 rotates further counter-clockwise, based on FIG. 9, until the lever element 30 points obliquely “upwards to the right” and pushes the long leg 43, which is positively guided with the tube mount 10 by means of the pivot lever 50, further “upwards” via the short leg 42.

This movement was continued in FIG. 10. The shaft 21 continues to rotate counter-clockwise, until the lever element 30 points vertically upwards and thus pushes the short leg 42 of the L-shaped linkage 40 upwards as a result of the guidance of the tube mount 10 and of the long leg 43, which is connected thereto, by means of the pivot linkage 50, so that the short leg 42 is aligned so as to point vertically upwards. The tube mount 10 is located in an “upper position”, in which the lowermost tube 4 is located in the beam path plane S.

A further option for designing the tube mount 10 is shown in FIG. 11. The shown channel 11 is bent in an inverted U-shaped or omega-shaped manner, respectively, so that a closed channel 11 is guided towards a beam path window 12, which is filled with an x-ray beam-transparent material for the x-ray fluorescent spectrometer 3, and is guided away again. A shielding 16 is provided behind the measuring point M, in which the beam path S1, S2 runs. In the shown embodiment, the tube 4, which is fluidically connected to a fluid bath not illustrated here, is further connected to both ends of the channel 11, without extending through the channel 11.

### LIST OF REFERENCE NUMERALS

1 device
2 housing
3 x-ray fluorescence spectrometer
4 tube
5 x-ray beam source
6 detector
7 housing wall
10 tube mount
11 channel
12 beam path window
13 x-ray beam sink
14 fastening bore
15 fastening bore
16 shielding
20 drive motor
21 shaft
22 control unit motor
30 lever element
31 triangular recess
32 corner
33 first end
34 slit
35 second end
36 passage bore
37 long side
38 threaded pin
39 threaded bore
40 linkage
41 pin
42 short leg
43 long leg
50 pivot linkage
51 counter bearing device
54 strip
55 pivot rod
56 pivot mount
57 control panel
58 on/off light
59 key switch
60 control device
61 electrical line
62 control unit x-ray fluorescence spectrometer
63 detector adapter board
70 pump
100 fluid bath
100′ fluid bath
101, 102 fluid lines
E tube plane
M measuring cell
S beam path plane
S1 input beam
S2 output beam

1.-17. (canceled)

18. A device (1) for carrying out online x-ray fluorescence analyses of at least one chemical fluid of a chemical fluid bath (100), comprising:
a housing (2);
a sample holder; and
an x-ray fluorescence spectrometer (3),
wherein the x-ray fluorescence spectrometer (3) provides a beam path of an input beam (S1) into the sample holder and an output beam (S2) of emitted x-ray radiation from the sample holder,
wherein the input beam (S1) and the output beam (S2) span a beam path plane(S),
wherein the sample holder is a tube mount (10),
wherein the tube mount (10) has a plurality of channels (11), each of the plurality of channels (11) being provided for a respective tube (4) of a plurality of tubes,
wherein the respective tube (4) is fluidically connected to the chemical fluid bath (100),
wherein the plurality of channels (11) are arranged adjacent to one another in a tube plane (E),
wherein the tube plane (E) is orthogonal to the beam path plane(S), and
wherein on each of the plurality of channels (11), the tube mount (10) has a respective beam path window (12),
wherein the respective beam path window can be arranged with respect to the beam path plane(S) such that the input beam (S1) and the output beam (S2) intersect with the respective beam path window (12).

19. The device (1) according to claim 18,
wherein the tube mount (10) is configured to be displaced in the tube plane (E) orthogonal to the beam path plane(S) and orthogonal to the channels (11),
wherein each of the beam path windows (12) can be arranged with the tube mount (10) with respect to the beam path plane(S) such that the input beam (S1) and the output beam (S2) intersect with the respective beam path window (12).

20. The device (1) according to claim 18,
wherein a respective one of the plurality of tubes is coupled to each channel (11) of the plurality of the channels (11),
wherein a first tube (4) of the plurality of tubes is fluidically connected to a first chemical fluid bath (100) and each further tube (4) of the plurality of tubes is fluidically connected to a further chemical fluid bath (100′).

21. The device (1) according to claim 18,
wherein the tube mount (10) is operatively coupled to a drive motor (20) via a coupling device,
wherein the coupling device has a lever element (30) and a transmission linkage (40),
wherein the lever element (30) connects the drive motor (20) and the transmission linkage (40),
wherein the transmission linkage (40) is connected to the tube mount (10).

22. The device (1) according to claim 21,
wherein the lever element (30) has, on a first end (33), a triangular clamping recess (31),
wherein one corner (32) of the triangular clamping recess (31) leads into a slit (34),
wherein the slit (34) opens towards the first end (33),
wherein a threaded bore (39) extends at a right angle from a long side (37) through the slit (34),
wherein adjacent to a second end (35), the lever element (30) has a passage bore (36),
wherein a shaft (21) extends away from the drive motor (20) and is fixed in the triangular clamping recess (31),
wherein a threaded pin (38) is arranged in the threaded bore (39) and clamps the shaft (21) in the triangular clamping recess (31),
wherein a pin (41) is rotatably arranged in the passage bore (36),
wherein the pin (41) couples the lever element (30) to the transmission linkage (40),
wherein the transmission linkage (40) is an L-shaped linkage (40) consisting of two legs (42, 43),
wherein the two legs (42, 43) are pivotably connected to one another,
wherein the lever element (30) is fastened to one end of a short leg (42) of the two legs (42, 43), and
wherein a long leg (43) of the two legs (42, 43) of the L-shaped linkage (40) is fastened to a side of the tube mount (10) facing away from the beam path windows (12).

23. The device (1) according to claim 18,
wherein each channel (11) has an x-ray beam sink (13) with respect to the respective beam path window (12) in a region of incidence of the input beam (S1).

24. The device (1) according to claim 18,
wherein the tube mount (10) is connected to at least one pivot linkage (50), the at least one pivot linkage (50) being fastened to the housing (2), so as to be pivotable in the tube plane (E), and/or
wherein the at least one pivot linkage (50) is displaceably coupled to at least one guide element (54), the at least one guide element (54) being fastened to the housing (2) and running in a direction orthogonal to the channels of the tube mount (10).

25. The device (1) according to claim 24,
wherein the guide element (54) is a guide rail, a gear wheel belt drive, or a polytetrafluoroethylene-coated strip.

26. The device (1) according to claim 18,
wherein the device (1) has a counter bearing device (51) with a ball mounted so as to be capable of rolling arranged on a side of the tube mount (10) facing away from the respective beam path window (12),
wherein the ball pushes the tube mount (10) towards the housing (2) orthogonal to the tube plane (E) in a region of the beam path plane (S).

27. The device (1) according to claim 21,
wherein a control device (60) is arranged in the housing (2), and
wherein the control device is electronically coupled to the drive motor (20) and the x-ray fluorescence spectrometer (3).

28. The device (1) according to claim 18,
wherein the tube (4) is fluidically connected to the chemical fluid bath (100) and coupled to a pump (70).

29. The device (1) according to claim 18,
wherein the chemical fluid bath (100) is a galvanic bath.

30. A method for an online x-ray fluorescence analysis of a chemical fluid from at least one chemical fluid bath (100) by using the device (1) according to claim 18, the method comprising:
a) establishing the fluidic connection of the tube (4) to one of the channels (11) of the tube mount (10) to the chemical fluid bath (100), and thereby providing the chemical fluid through the tube (4) in the one of the channels (11);
b) turning on the x-ray fluorescence spectrometer (3) and generating the beam path of the input beam (S1) and the output beam (S2) of emitted x-ray radiation, thereby irradiating the chemical fluid; and
c) analyzing the chemical fluid by detecting of the emitted x-ray radiation.

31. The method according to claim 30, further comprising:
d) repeating at least step c) after a predetermined time period.

32. A method for an online x-ray fluorescence analysis of a first chemical fluid from a first chemical fluid bath (100) and of at least one further chemical fluid from a further chemical fluid bath (100′) by using the device according to claim 20, the method comprising:
aa) establishing the fluidic connection of a first one of the plurality of the tubes (4) to a first channel of the channels (11) of the tube mount (10) to the first chemical fluid bath (100), and thereby providing the first chemical fluid through the first tube (4) in the first channel (11), and positioning the beam path window (12) of the first channel (11) with the tube mount (10) in the beam path;
bb) turning on the x-ray fluorescence spectrometer (3) and generating the beam path of the input beam (S1) and the output beam (S2) of emitted x-ray radiation, thereby irradiating the first chemical fluid;
cc) analyzing the first chemical fluid by detecting the emitted x-ray radiation;
dd) providing and activating the fluidic connection of a further one of the plurality of the tubes (4), the further one of the plurality of the tubes (4) being fluidically connected to a further one of the chemical fluid baths (100), and thereby providing a second chemical fluid in the further tube (4), after analyzing the first chemical fluid;
ee) displacing the tube mount (10) in the tube plane (E) and positioning the beam path window (12) of the further channel (11) in the beam path after analyzing the first chemical fluid; and
ff) analyzing the further chemical fluid by detecting the emitted x-ray radiation.

33. The method according to claim 32, further comprising
gg) repeating steps aa) to ff) or of steps dd) to ff) and thereby analyzing the chemical fluids once or several times in all tubes (4) of the plurality of tubes (4).

34. The method according to claim 32, further comprising
hh) repeating steps cc) and ff) after a predetermined time period.
